(19) United States
(12) Patent Application Publication
(10) Pub. No.: US 2014/0058632 A1
(43) Pub. Date: Feb. 27, 2014

(54) VEHICLE SAFETY PORTABLE DEVICE DISABLEMENT TECHNOLOGY

(71) Applicant: Frank J. Jungman, Escondido, CA (US)

(72) Inventor: Frank J. Jungman, Escondido, CA (US)

(73) Assignee: Vehicle Safety Innovations, Inc., Escondido, CA (US)

(21) Appl. No.: 13/595,977

(22) Filed: Aug. 27, 2012

(51) Int. Cl. G06F 17/00

(52) U.S. Cl. 701/48

(57) ABSTRACT

A vehicle safety system that disables features of a portable device as a condition for starting of the vehicle. The system includes vehicle safety communication module, and a detector module that detects presence of a portable device in the vehicle, and in response, causes the portable device to communicate with the vehicle safety communication module. A starter interlock module controls enablement and disablement of a starter system of the vehicle, and keeps the starter system disabled absent instructions to the contrary from the vehicle safety communication module. Upon communication with the portable device, the vehicle safety communication module causes the portable device to disable features of the portable device while causing the starter interlock module to enable the starter system of the vehicle. When the vehicle is stopped, the vehicle communication system again enables the portable device.

### BACKGROUND

Wireless portable communication devices have transformed the way we communicate. For instance, many carry mobile telephones and highly capable smart phones substantially wherever they go. Smart phones not only operate as a telephone, but also have the ability to assist the user in texting, allow the user to navigate the Internet, alter the user of appointments or other events (such as incoming mail, texts, of voice mail), provide games and other applications with complex user interfaces, and so forth. Smart phones are essentially a small general purpose computing system. Smart phones have thus proved to be very useful to society.

However, smart phones can have a significant downside if not used with good judgment. For instance, vehicle safety is often compromised when drivers overestimate their capacity to focus on safe driving while also having some focus on their smart phones. Thus, much injury and death has resulted from accidents caused by drivers that were inattentively driving due to being distracted by the smart phone.

There have been several conventional attempts to solve this serious societal problem. One involves using a global positioning system (GPS) system embedded in the smart phone itself. When an application on the smart phone detects from GPS coordinates that the driver may be moving consistent with the characteristics of being in a moving vehicle, the application disables features of the smart phone. However, this class of solutions cannot differentiate between when the user is driving a vehicle, and other situations in which the user might be moving, but not driving (such as riding a bus or train). Accordingly, the smart phone is sometimes needlessly disabled, thereby inconveniencing the user with no safety benefit. Furthermore, the solution does not work where GPS signals are weak or somehow the GPS sensors within the smart phone are actually shielded from external electromagnetic signals.

Another convention solution is to establish a plug-in data connection between the smart phone and the vehicle diagnostics system. When the vehicle is being driven, the smart phone detects this from the diagnostics system, and features of the smart phone are disabled. However, this relies on the cooperation of the driver to keep the smart phone connected to the diagnostics system.

### BRIEF SUMMARY

At least one embodiment described herein relates to a vehicle safety system that disables at least part of one or more features of a portable device as a condition of enabling the starting of the vehicle. The system includes a vehicle safety communication module, and a detector module that detects presence of a portable device in the vehicle (e.g., as from a swipe of the device). As a result of the proximity detection, the detector module causes the portable device to communicate with the vehicle safety communication module. A starter interlock module controls enablement and disablement of the starting of the vehicle, and keeps the starting disabled absent instructions to the contrary from the vehicle safety communication module.

Upon communication with the portable device, the vehicle safety communication module, at least under some circumstances, causes the portable device to disable at least one feature of the portable device while causing the starter interlock module to enable the starting of the vehicle. When the vehicle is stopped, the vehicle communication system again enables the portable device perhaps after the presence of the portable device is again detected (e.g., as from a swipe of the device). Thus, one or more features of the portable device are disabled, preventing driver distraction while the driver is driving the vehicle.

In some embodiments, the identity of the portable device is also used to determine whether or not the user is even authorized to drive the vehicle at all. Thus, the system may also be used to restrict who uses the vehicle. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates an environment in which a safety system interacts with a portable device in order to improve vehicle safety;

FIG. 2 illustrates a flowchart of a method for a safety system to improve safety of vehicle operation by disabling features of a portable device as a condition for enabling start of a vehicle;

FIG. 3 illustrates a flowchart of a method for the safety system re-enabling the features disabled by the method of FIG. 2, after the vehicle has been disabled from being self-propelled;

FIG. 4 illustrates a flowchart of a method for the portable device to interface with the safety system to support the methods of FIGS. 2 and 3;

FIG. 5 abstractly illustrates a supervisory system in accordance with the principles described herein; and

FIG. 6 illustrates a computing system in which some embodiments described herein may be employed.

### DETAILED DESCRIPTION

At least one embodiment described herein relates to a vehicle safety system that disables at least part of one or more features of a portable device as a condition of enabling the self-propulsion (referred to hereinafter as “starting”) of the vehicle. Upon detecting the proximity of the portable device in the vehicle, and after perhaps also authorizing the user of the portable device as an authorized driver of the vehicle, the starting system of the vehicle is enabled and one or more features of the portable device are disabled. This prevents such disabled features from distracting the driver while operating the vehicle. When the vehicle is disabled from self-propulsion (referred to hereinafter as “stopping” the vehicle), the features may again be enabled. For instance, a combustion engine powered car is “stopped” when the engine is not off, and an electric powered car is “stopped” if the motivator is off. Although the principles described herein are described with respect to a driver and a vehicle, the principles may also be extended to any operator and any machinery operated by the operator.

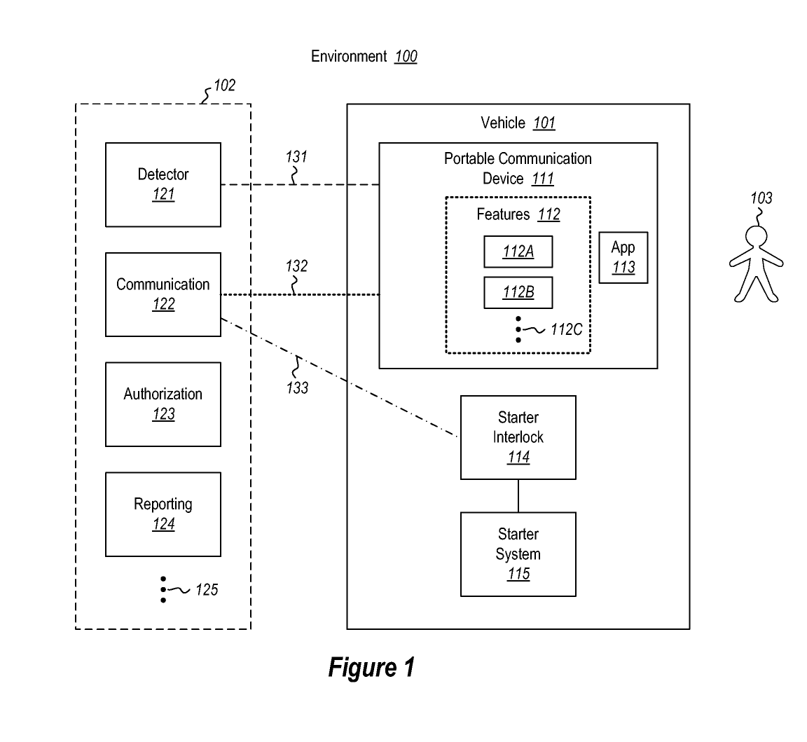

FIG. 1 illustrates an environment 100 that includes a vehicle 101 that is operated by, for example, driver 103. The driver 103 has a corresponding portable device 111 that has a number of operational features 112. Examples of a portable device 111 include a smart phone, a mobile telephone, a texting device, an iPad like device, a tablet computer, an entertainment device, a notification or information device, or the like. In any case, the portable device 111 is portable and thus may be carried with the driver 103 before, during, and after operating the vehicle 101. However, the forms of portable devices are changing rapidly, and the principles described herein are not limited to currently existing forms of portable devices.

The operational features 112 are illustrated as abstractly including two features 112A and 112B, although the ellipses 112C represent a great variety of features that are capable of being deployed on the portable device 111. Such features can be useful and/or entertaining while the driver is not operating the vehicle 101. However, if the driver is operating the vehicle, such features 112 have the serious potential of distracting the driver 103 while the driver 103 is operating the vehicle 101. Much avoidable injury and death has occurred due to inattentive driving caused by driver distraction by portable devices. Features that have the potential to distract drivers include texting, internet navigation, telephone conversations, alerts, checking and generating e-mail, and even games. With enormous numbers of applications are now available to run on smart phones, the fact that the potential for driver distraction remains is a serious unresolved problem.

Referring again to FIG. 1, in accordance with the principles described herein, the system 102 (hereinafter also referred to as a “safety system”) improves safety in the operation of the vehicle 101 by disabling one or more features 112 of the driver's portable device 111 to thereby remove distractions from the important responsibility to drive attentively.

Although the safety system 102 is illustrated abstractly as being external to the vehicle 101, in the embodiments described further herein, the safety system is contained completely within the vehicle 101. Furthermore, although various modules 121 through 124 of the safety system 102 are illustrated as being separate, this is for purpose of clarity only. In implementation, the functionality from such modules may be combined into another module and/or into a single device, or the functionality described with respect to that module may be distributed into separate devices.

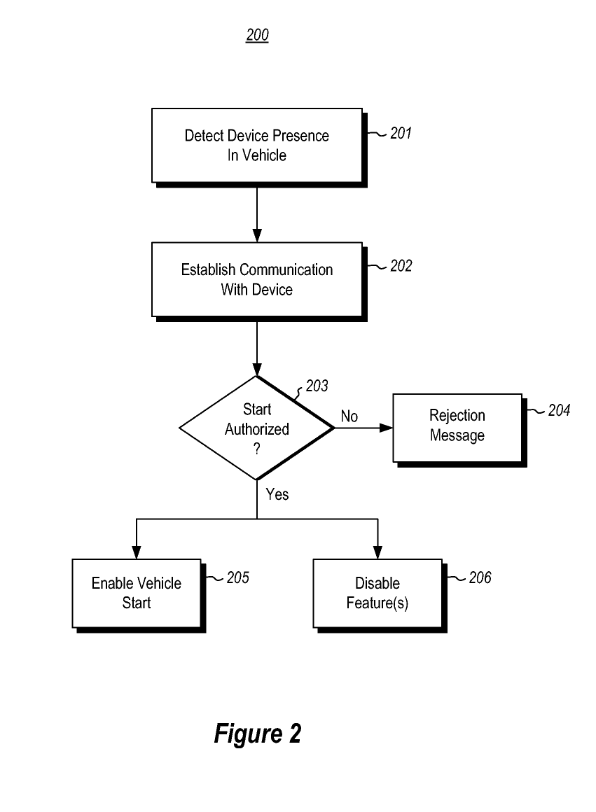

FIG. 2 illustrates a flowchart of a method 200 for improving safety of vehicle operation. As the method 200 may be performed by the system 102 of FIG. 1 in the context of the environment 100 of FIG. 1, FIGS. 1 and 2 will be described with reference to each other.

The safety system 102 includes a detector module 121 that is configured to detect presence of a portable device 111 within a vehicle 101 (refer to act 201 of FIG. 2). This detection is represented symbolically by the dashed line 131. In some cases, the detector module is a near field communication (NFC) sensor. The NFC sensor detects proximity of the portable device 111 by for example, passing the portable device 111 into close proximity to the detector module 121. As an example, the detector module 121 may be on or near the dashboard of the vehicle, making it convenient for the driver to simply move the portable device to within detecting proximity of the detector module 121. For instance, the driver may merely swipe the portable communicating device 111 towards the dashboard, and the portable device 111 would be detected, even if contained inside of a carrier bag, purse, wallet, or the like, and even if embedded inside of a human body.

The safety system 102 also including a communication module 122. In response to the detector module 121 detecting proximity of the portable device 111 (act 201), the communication module 122 of the safety system 102 and the portable device 111 establish a communication channel (reference act 202 of FIG. 2, and abstractly represented by dotted line 132 in FIG. 1). As an example, the communication might be accomplished via BLUETOOTH® technology. In one embodiment, this communication channel 132 may be enabled for the duration of the driving experience. The portable device 111 may include a software application 113 (colloquially referred to as an “app”) that receives the communications from and provides information to the communication module 122 at the application level.

Optionally, authorization is also incorporated into the safety system 102. In that case, the safety system 102 includes an authorization module 123, which determines whether presence of the portable device authorizes a start of the vehicle 101 (decision block 203). The authorization module 123 may determine this based on an identity of the portable device 111. Such an identity might be, for example, a telephone number communicated by the application 113 on the portable device 111 to the communication module 122 in the safety system 102.

If the user associated with the portable device 111 is not authorized to start the vehicle (“No” in decision block 203), then the communication module 122 may communicate that to the portable device 111 (act 204), causing the application 113 to indicate this to the user. In one embodiment, the safety system 102 also has a reporting module 124, which reports this unauthorized access attempt perhaps also with the identity of the portable device (e.g., the telephone number). This reporting (and as with any reporting described herein) may take the form of reporting the event on a local memory. Alternatively or in addition, the reporting module 124 may report this information (and as with any further reporting described herein) by causing the communication module 122 to use the data connection 132 to control the portable device 111 to report information to a supervising system in real-time. For instance, the portable device 111 may communicate the event using the Internet. The supervising system might be a smart phone, laptop or other computer belonging to a parent (in the case of the driver being a son or daughter), or a supervisor (in the case of the driver being a worker). Alternatively or in addition, the reporting module 124 might also use a built in telematics system such as ONSTAR to report events.

On the other hand, if the user of the portable device 111 is authorized (“Yes” in decision block 203), then at least under some circumstance (such as the authorization or the satisfaction of one or more other conditions), the vehicle safety communication module 122 is configured to cause the starter system 115 of the vehicle to be enabled (act 205). For instance, the vehicle safety communication module 122 may communicate with a starter interlock module 114 as represented by intermittent dotted-dashed line 133. The starter interlock module 114 controls the enablement and disablement of the starter system 115 of the vehicle 101. When the vehicle 101 is not in use, the starter interlock module 114 keeps the starter system 115 disabled, but in response to instructions from the vehicle safety communication module 112 causes the starter system 115 of the vehicle 101 to be enabled. The starter interlock module 114 may be connected to the vehicle bus, or perhaps to the starter wires of the vehicle.

In addition, the vehicle safety communication system 102 causes the portable device 111 to disable at least part of one or more of its features 112 (act 206). This may be accomplished by the vehicle safety communication module 122 instructing the portable device 111, thereby causing the software application 113 to enforce the instruction to disable the features. For instance, the disabled features might include at least part of any one or more of the following: texting, non-emergency communication, displaying, alerting, and input detection. In this state, the vehicle 101 may now be started as per normal. In addition, the portable device now has at least one feature disabled thereby reducing the potential for distracted driving. It is preferred that emergency communication (such as 911 calls) never be disabled.

The system 102 is capable of reporting hacking attempts of the safety system 102. Such hacking attempts may be logged in local memory. Furthermore, recall that the vehicle safety communication module 122 and the portable device 111 may maintain communication over data link 132, with application 113 remaining responsive to instructions from the vehicle safety communication module 122. Thus, hacking attempts may also be reported in real-time to the supervisory system using an Internet connection of the portable device 111. As an example, such hacking may involve the disabling or bypassing of the application 113. In addition, the hacking might involve breaking the data link 132. This may be accomplished through monitoring of the voltages on the connected wires and the data on the vehicle diagnostic bus (CAN or others).

For instance, the reporting module 124 may report an unauthorized start of the vehicle if the starter interlock module 114 detects a start of the vehicle 101 without having received an instruction to enable the starting system 115 (e.g., which would mean the detector module 121 has not detected proximity of an authorized portable device in the vehicle 101). Furthermore, the vehicle safety communication module 122 detects (and thus may also report), when a portion or all of the at least one disabled features of the portable device are again enabled while the vehicle is still running.

The reporting module 124 may also report geographic coordinates of the vehicle 101 (whether in real-time and/or just to a log in local memory). The vehicle safety communication module 122 may acquire such coordinates from a satellite-based positioning system in the portable device 111 if the device 111 is equipped with such a system. An example of such a system is a Global Positioning System (GPS) system. To ensure that the portable device 111 remains powered, the safety system may include for example, a power charger. The ellipses 125 symbolically represent that the safety system may have other features not described or illustrated. In one possible implementation, the detector module 121 is mounted to the dashboard, whereas the vehicle communication module 122, the authorization module 123, and the reporting module 124 are each integrated with the starter interlock module 115, which may be positioned under the dashboard or wherever else is convenient to connect to the starter system 114 of the vehicle 101.

The vehicle safety communication module 122 may also cause the portable device 111 to use a network connection (e.g., an Internet connection) to download a set of authorized identities to use the vehicle 101, and cause the portable device 111 to provide that set back to the communication module 122 for use by the authorization module 123. This is true for any type of data. When the vehicle safety communication module 122 uses the portable device 111 to transmit data over the Internet, or receive data over the Internet, such data may be encrypted. The data may be encrypted using a private key corresponding to the supervisor, and decrypted using a public key. Furthermore, the data may be electronically signed to ensure the data has not been tampered with, for example, by tampering with the application 113. Such tampering may be detected by the vehicle safety communication module 122 and reported.

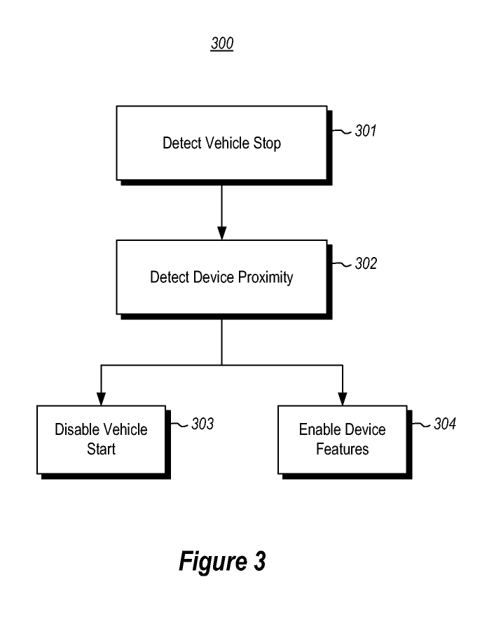

FIG. 3 illustrates a flowchart of a method 300 associated with enabling the portable device 111 after the vehicle 101 stops. First, the vehicle is detected to have stopped (act 301). The starter interlock module 114 may detect this and report to the vehicle communication module 122 over the data channel 133. Then, the driver swipes the portable device into close proximity to the detector module 121 if intending to leave the vehicle. Accordingly, the detector module 121 again detects proximity of the portable device 111 (act 302). In response, the vehicle safety communication module 122 causes the starter system 115 to be disabled (act 303) for instance by providing an instruction to the starter interlock module 114. Furthermore, the vehicle safety communication module 122 once again enables the disabled features of the portable device 111 (act 304). Thus, the driver leaving the vehicle with a fully functional portable device 111, having completed a safer trip that he or she might have without the principles described herein. Note the method 300 is performed after the vehicle has stopped. If the driver swipes the portable device into close proximity to the detector module 121 while the vehicle is still running, then the vehicle safety system 102 may cause the portable device 111 to prompt the driver to stop the vehicle and retry the swipe (e.g., via a tone or voice prompt).

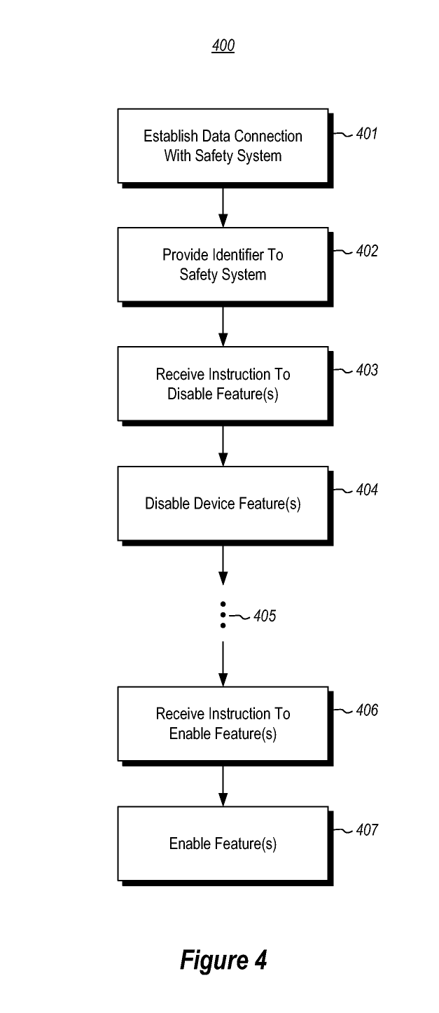

While FIGS. 2 and 3 describe methods for engaging and disengaging the starter system from the perspective of the safety system 102, FIG. 4 illustrates a flowchart of a method 400 for the portable device 111 to interact with a vehicle safety communication module 122. The portable device 111 establishes a wireless communication channel with the vehicle safety communication module 122 (act 401, and reference line 132). This is the same wireless communication channel as was created in act 202 of FIG. 2.

The portable device 102 then provides an identifier (such as a telephone number) to the communication module of the safety system 102 (act 402). It is from this identifier that the authorization module 123 can determine whether the portable device is authorized (reference decision block 203 of FIG. 2). The portable device 111 (after being authorized in decision block 203), is then instructed to disable at least part of one or more features of the portable device (act 403). The portable device 111 responds to the instruction by disabling the at least part of the one or more features (act 404).

As abstractly represented by ellipses 405, and as previously mentioned, the portable device 111 (or more specifically the application 113) responds to further instructions from the vehicle safety communication module 122 while the vehicle start system is enabled, and the vehicle is running For instance, the portable device 111 may be instructed to download data over a network such as the Internet and provide such data to the safety vehicle communication module 122, and also reports information over the network to a supervisor system when instructed to do so by the safety system 102.

Upon receiving an instruction to re-enable the disabled features (act 406) (e.g., after the vehicle 101 has stopped), the portable device 111 responds by re-enabling the disabled features (act 407).

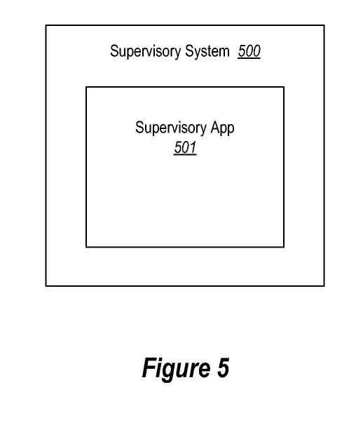

A supervisor is a person desiring that the driver engage in safe driving. For instance, if the driver were a son or daughter, the supervisor might be a parent. If the driver were a worker (e.g., one of many drivers of a fleet of vehicles), the supervisor might be a fleet owner or manager. FIG. 5 illustrates a supervisory system 500. The supervisory system 500 may be a computing system such as a distributed system, or perhaps may be a non-distributed computing system or a device, such as a mobile phone, laptop, tablet computer or the like. The supervisory system 500 runs a software supervisory application 501 thereon.

As previously mentioned, the vehicle safety communication module 122 may use the portable device 111 to download a list of authorized telephone numbers. Alternatively or in addition, the supervisory system 500 may also be a portable device, such as portable device 111. Thus, the owner of the supervisory system 500 may be a self-authorized driver of the vehicle 111. In addition, the supervisory system, if portable, may use a similar system as that described by FIG. 1 in order to populate the authorization module 123 with authorized telephone numbers.

For instance, the supervisor may place the portable device 111 with the supervisory application 501 in close proximity to the detector module 121, causing the vehicle safety communication module 122 and the supervisory portable device to establish a communication link. When the vehicle safety communication module 122 reads the telephone number of the supervisory portable device, the authorization module 123 recognizes the session as allowing authorized telephone numbers to be set (since the user is a supervisory user). Furthermore, configuration settings may also be set. For instance, the supervisor might use supervisory application 501 to set authorized users (or specifically their telephone numbers), authorized driving times, the particular features that will be disabled upon enabling the starting system, whether geographic coordinates will be reported (and perhaps between what times), the nature of other information that will be reported, and whether in real-time or just to the log, and so forth. Thus, the supervisor may maintain some control over the safe use of the vehicle, even when not themselves driving the vehicle.

When disabling the one or more features of the portable device, other actions may be taken. For instance, the safety system might disable a car alarm system (or subset of a car alarm system, such as window break sensors, hood sensors and towing sensors). Also, when enabling the one or more features of the portable device, other actions may be taken, such as reversing the actions taken when disabling the features of the portable device. For instance, the car alarm system (or the disabled subset of the car alarm system) may again be enabled.

On some occasions, the vehicle is to be entrusted to a third-party who is not technically an authorized user (such as a valet, mechanic, car wash attendant, and so forth). This could be for a few minutes or a month or more. An example of how this might be accomplished for a vehicle with safety system 102 will now be described. The vehicle is first unlocked and either started or cleared to start. A special mode (such as “Valet mode”) is set on the portable device. In this mode, the portable device unlocks once the data link 132 is lost (e.g., the BLUETOOTH connection is lost due to the portable device wandering out of range as the authorized driver walks away). The vehicle remains unlocked until proximity of the portable device is again detected (e.g., when the BLUETOOTH connection is again detected and paired again). In the case of there being a need for unlimited starts/stops, the portable device locks when BLUETOOTH pairs again, and prompts to turn the valet mode off. The application 113 keeps the BLUETOOTH discovery mechanism turned on. Optionally, the use of the valet is reported to the supervisor.

Another mode is “lost phone” mode. This is for the extreme case in which the portable device is really gone and the driver is stranded. In this case, there may be a series of operations programmed at installation that will unlock the car (e.g., press brake pedal three times, cycle ignition twice, press brake twice). The car then will allow starting some time after (e.g., perhaps one to five minutes to disincentivize use in all but the legitimate use case). The use of lost phone mode is then reported to the supervisor, who can reprogram the sequence if needed to stop abuse.

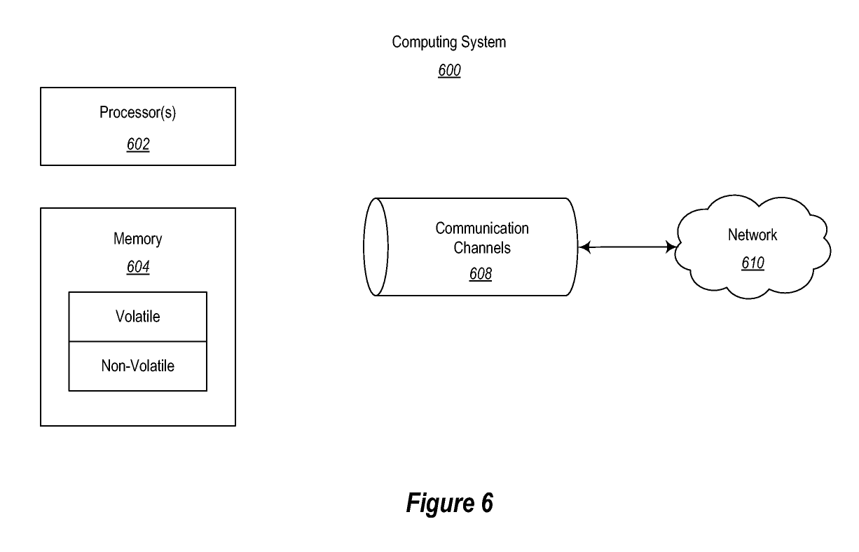

The safety system 102 and the supervisory system 500 may in fact be a computing system (although perhaps a miniature computing system) with a processor and a memory. FIG. 6 abstractly illustrates a computing system. Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 6, in its most basic configuration, a computing system 600 typically includes at least one processing unit 602 and memory 604. The memory 604 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 604 of the computing system 600. Computing system 600 may also contain communication channels 608 that allow the computing system 600 to communicate with other message processors over, for example, network 610.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Thus, an effective system for improving vehicle safety has been described. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system comprising:
a vehicle safety communication module;
a detector module that is configured to detect presence of a portable device in a vehicle, and in response cause the portable device to communicate with the vehicle safety communication module; and
a starter interlock module configured to control enablement and disablement of the starting of the vehicle, the starter interlock module configured to keep starting disabled absent instructions to the contrary from the vehicle safety communication module;
wherein upon communication with the portable device, the vehicle safety communication module is at least under some circumstances configured to both cause the portable device to disable at least one feature of the portable device and cause the starter interlock module to enable the starting of the vehicle.

2. The system in accordance with claim 1, wherein at least one disabled feature comprises at least part of one or more of texting, non-emergency communication, displaying, altering, and input detection.

3. The system in accordance with claim 1, wherein the detector module is configured to detect presence of the portable device in the vehicle by the detector module being located in the vehicle and by using near field communication to detect proximity of the portable device.

4. The system in accordance with claim 1, wherein the vehicle safety communication module is further configured to cause the at least one disabled feature of the portable device to be enabled in at least some circumstances when the vehicle is no longer running.

5. The system in accordance with claim 4, wherein upon the detector module again detecting proximity of the portable device after the vehicle is no longer running, the vehicle safety communication device is configured to cause the portable device to enable the at least one disabled feature of the portable device, and cause the starter interlock module to disable the starting of the vehicle.

6. The system in accordance with claim 1, further comprising:
an authorization module configured to determine whether presence of the portable device authorizes a start of the vehicle based on an identity of the portable device, wherein the at least some circumstances under which the vehicle safety communication module is configured to cause the starting of the vehicle to be enabled comprises the authorization module determining that the presence of the portable device authorizes start.

7. The system in accordance with claim 6, further comprising:
a reporting module that is configured, in the event of the authorization module determining that the portable device is not authorized, to report event information related to the unauthorized start or attempted start including at least the identity of the portable device.

8. The system in accordance with claim 6, wherein the vehicle safety communication module is configured to cause the portable device to use a network connection to download a set of authorized identities to use the vehicle, and provide that set back to the portable device for use by the authorization module.

9. The system in accordance with claim 1, further comprising:
a reporting module that is configured to report an unauthorized start of the vehicle if the starter interlock module detects a start of the vehicle without the detector module having detected proximity of the portable device in the vehicle.

10. The system in accordance with claim 1, further comprising:
a reporting module that is configured to report an attempt to disable or bypass a security application on the portable device.

11. The system in accordance with claim 1, further comprising:
a reporting module that is configured to report attempts to break communication between the vehicle safety communication module and the portable device.

12. The system in accordance with claim 1, wherein the vehicle safety communication module causes geographic coordinates of the vehicle to be reported.

13. The system in accordance with claim 10, wherein the vehicle safety communication module receives the geographic coordinates from the portable device.

14. The system in accordance with claim 1, wherein the vehicle safety communication module is configured to use a data connection of the portable device to report information to a supervising system in real-time.

15. The system in accordance with claim 1, wherein the vehicle safety communication module is configured to detect and report when a portion or all of the at least one disabled features of the portable device are again enabled while the vehicle is still running.

16. The system in accordance with claim 1, wherein the starter interlock module and the vehicle safety communication module are integrated into a single device.

17. A system comprising:
a vehicle safety communication module;
a detector module that is configured to detect presence of a supervisory portable device in a vehicle, and in response cause the supervisory portable device to communicate with the vehicle safety communication module;
a starter interlock module configured to control enablement and disablement of a starter system of the vehicle, the starter interlock module configured to keep the starter system disabled absent instructions to the contrary from the vehicle safety communication module;
an authorization module, wherein upon communication with the supervisory portable device, the vehicle safety communication module is at least under some circumstances operative to configure the authorization module to recognize at least one non-supervisory portable device as being authorized to start the vehicle,
wherein, if the authorization module determines that a proximate portable device is authorized to start the vehicle, the vehicle safety communication module is configured to both cause the proximate communication device to disable at least one feature of the proximate portable device and cause the starter interlock module to enable the starting of the vehicle.

18. The system in accordance with claim 17, wherein the configuring of the authorization module also comprises restricting authorization corresponding to a given proximate portable device to particular times.

19. The system in accordance with claim 17, wherein the configuring of the authorization module also comprises custom feature disablement such that one non-supervisory portable device may have different features disabled than another non-supervisory portable device.

20. A computer program product comprising one or more computer-storage media having thereon computer-executable instructions that, when executed by one or more processors of a portable device, cause the portable device to perform a method for the portable device interacting with a vehicle safety communication module located in a vehicle, the method comprising:
an act of the portable device establishing a wireless communication channel with the vehicle safety communication module;
an act of the portable device providing an identifier of the portable communication module to the vehicle safety communication module over the wireless communication channel;
an act of the portable device receiving instruction from the vehicle safety communication module to disable at least part of one or more features of the portable device; and
an act of the portable device responding to the instruction by disabling the at least part of the one or more features.

21. The computer program product in accordance with claim 20, wherein the method further comprises:
an act of the portable device retrieving data over a network and providing the retrieved data to the vehicle safety communication module over the wireless data connection; and
an act of the portable device receiving data from the vehicle safety communication module over the wireless data connection, and communicating that data over the network.

22. The computer program product in accordance with claim 21, wherein the network is the Internet, and wherein the wireless communication channel is a Bluetooth wireless communication channel.
